(19) United States
(12) Patent Application Publication
(10) Pub. No.: US 2019/0005811 A1
(43) Pub. Date: Jan. 3, 2019

(54) SYSTEMS AND METHODS FOR DOWNLOADING DATA FROM A MONITORING DEVICE TO A MOBILE DEVICE

(71) Applicant: Honeywell International Inc., Morristown, NJ (US)

(72) Inventors: Gaetano Saia, Monfalcone (IT); Nicolaas Van Klaveren, Mougins (FR); Zhenyi Hua, Shanghai (CN); Junyu Ma, Shanghai (CN); Dongke Li, Shanghai (CN)

(21) Appl. No.: 16/018,329

(22) Filed: Jun. 26, 2018

Related U.S. Application Data
(60) Provisional application No. 62/527,142, filed on Jun. 30, 2017.

(51) Int. Cl. G08C 23/02; G10L 19/005; H04B 11/00

(52) U.S. Cl. CPC G08C 23/02; H04B 11/00; G10L 19/005

(57) ABSTRACT

Systems and methods for downloading data from a monitoring device to a mobile device are provided. Such systems and methods can include the monitoring device transmitting, via an audio generating device, data to the mobile device in a non-audible, high frequency audio signal, a microphone of the mobile device receiving the non-audible, high frequency audio signal, and a processor of the mobile device decoding the data from the non-audible, high frequency audible signal.

### CROSS REFERENCE TO RELATED APPLICATIONS

This application claims priority to U.S. Provisional Patent Application No. 62/527,142 filed Jun. 30, 2017 and titled “SYSTEMS AND METHODS FOR DOWNLOADING DATA FROM A MONITORING DEVICE TO A MOBILE DEVICE.” U.S. Provisional Patent Application No. 62/527,142 is hereby incorporated by reference.

### FIELD

The present invention relates to monitoring devices. More particularly, the present invention relates to systems and methods for downloading data from a monitoring device to a mobile device.

### BACKGROUND

Battery powered smoke detectors and carbon monoxide detectors are known in the art, and wirelessly downloading data from the smoke detectors and the carbon monoxide detectors to a mobile device is also known in the art. For example, some known systems and methods include an audio link application on the mobile device that facilitates downloading the data from a detector, wherein the data includes a history log of alarm events and fault events. These known systems and methods use a speaker or a buzzer in the detector to transmit the data to the mobile device and a microphone in the mobile device to receive the data from the detector.

Subsequently, the data as downloaded can be emailed or otherwise transmitted from or presented by the mobile device to a user so that the user can investigate the data or use the data to improve the detector going forward.

Some known systems and methods use audible, high volume, low frequency sounds (2-4 kHz) to download the data from the detector to the mobile device. However, such high volume sounds are uncomfortable to users within hearing range of the detector during download. Alternatively, some known systems and methods use low volume sounds to download the data from the detector to the mobile device. However, such low volume sounds have a low transmission speed.

In view of the above, there is a continuing, ongoing need for improved systems and methods.

### BRIEF DESCRIPTION OF THE DRAWINGS

FIG. 1 is a block diagram of a system in accordance with disclosed embodiments; and

FIG. 2 is a flow diagram of a method in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for downloading data from a monitoring device to a mobile device. For example, the monitoring device can transmit the data to the mobile device, and a microphone in the mobile device can receive the data from the monitoring device. In some embodiments, the monitoring device can transmit the data via an integrated speaker, buzzer, or similar audio generating device broadcasting a non-audible, high frequency audio signal.

It is to be understood that the monitoring device as disclosed and described herein can include a wired or wireless smoke detector, carbon monoxide detector, fire detector, or IoT device as would be understood by one of ordinary skill in the art. In some embodiments, the mobile device can include a user device, such as a smart phone as would be known and understood by one of ordinary skill in the art.

In accordance with disclosed embodiments, the monitoring device can wirelessly transmit the data to the mobile device in the non-audible, high frequency audio signal, and in some embodiments, such a signal can be a non-RF signal. In accordance with disclosed embodiments, even though the signal transmitted by the monitoring device is not audibly perceptible to a user, the signal can be detected by the microphone of the mobile device.

In some embodiments, because the data is transmitted at the high frequency, systems and methods disclosed herein can transmit the data at a high rate and have a high transmission speed that, for example, allows the data to download in less than 30 seconds. In some embodiments, the high frequency can be approximately 18 kHz or higher, and in some embodiments, the high frequency can be approximately 20 kHz. In some embodiments, systems and methods disclosed herein can use variable length data coding to decrease an average time to download the data.

In some embodiments, upon receiving the data, the mobile device or a processer thereof can execute an audio analytics application to decode the data and present the data, audibly or visually, in a manner that can be understood by the user. In some embodiments, the mobile device can estimate and compensate for frequency error on the signal received from the monitoring device. For example, the processor can compensate for the frequency error by estimating missing portions of the data from uncorrupted portions of the data.

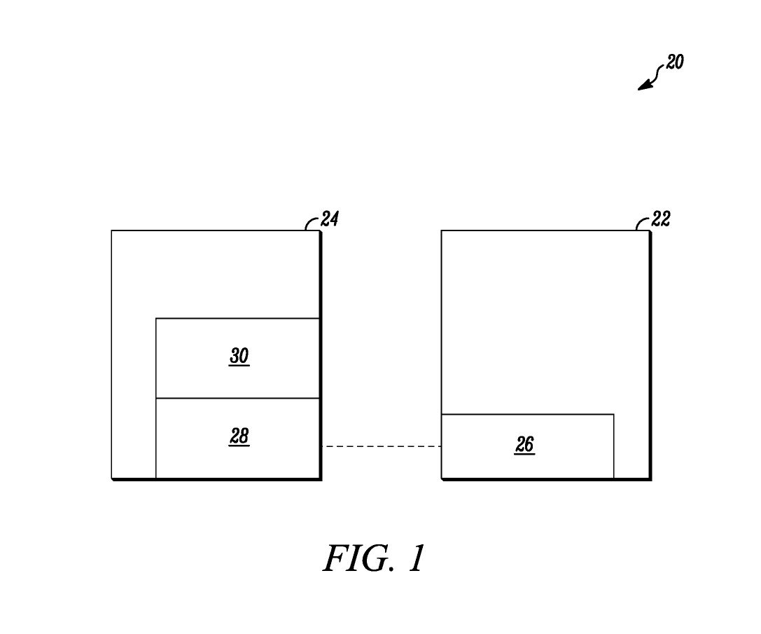

FIG. 1 is a block diagram of a system 20 in accordance with disclosed embodiments. As seen in FIG. 1, the system 20 can include a monitoring device 22 and a mobile device 24. As also seen in FIG. 1, the monitoring device 22 can include an audio generating device 26, such as a speaker or a buzzer, and the mobile device 24 can include a microphone 28 and a processor 30. As disclosed herein, the audio generating device 26 can transmit data to the mobile device 24 in a non-audible, high frequency audio signal, and the microphone 28 can obtain the data from the monitoring device by receiving the non-audible, high frequency audio signal transmitted by the audio generating device 26.

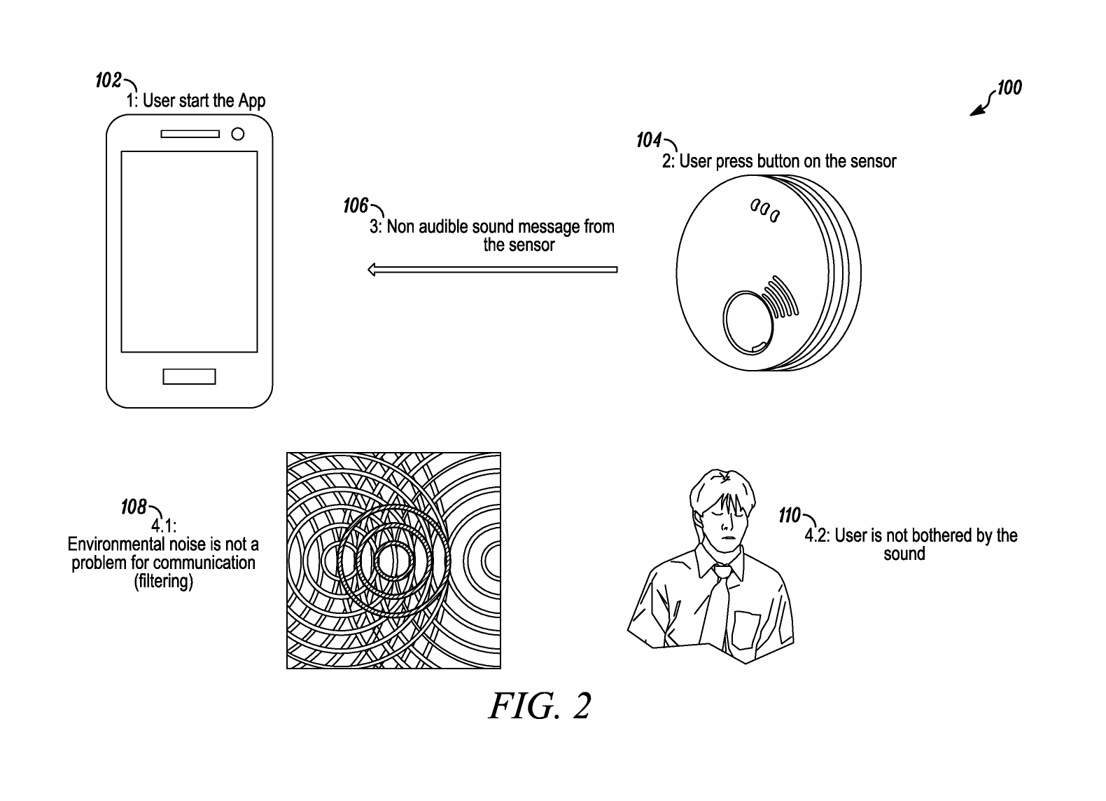

FIG. 2 is a flow diagram of a method 100 in accordance with disclosed embodiments. As seen in FIG. 2, the method 100 can include the mobile device 24 receiving first user input to launch a software application being executed on the mobile device 24, as in 102. Then, the method 100 can include the monitoring device 22 receiving second user input, such as a user depressing a button on the monitoring device 22, to initiate transmission of the non- audible, high frequency audio signal that includes the data, as in 104, and the audio generating device 26 of the monitoring device 22 transmitting the non-audible, high frequency audio signal, as in 106. Finally, the method 100 can include the processor 28 of the mobile device 24 filtering out environmental noise received by the microphone 28, as in 108, and the microphone 28 of the mobile device 24 receiving the data in the non-audible, high frequency audio signal from the monitoring device 22, thereby obtaining the data from the monitoring device 22 without bothering the user of the mobile device 24 with harsh noises, as in 110.

Although a few embodiments have been described in detail above, other modifications are possible. For example, the logic flows described above do not require the particular order described or sequential order to achieve desirable results. Other steps may be provided, steps may be eliminated from the described flows, and other components may be added to or removed from the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A system comprising:
a monitoring device that includes an audio generating device; and
a mobile device that includes a microphone and a processor,
wherein the monitoring device transmits, via the audio generating device, data to the mobile device in a non-audible, high frequency audio signal, and
wherein the mobile device receives, via the microphone, the non-audible, high frequency audio signal and decodes, via the processor, the data from the non-audible, high frequency audio signal.

2. The system of claim 1 wherein the processor compensates for frequency error in the non-audible, high frequency audio signal by estimating missing portions of the data from uncorrupted portions of the data.

3. The systems of claim 1 wherein the monitoring device transmits the data at a high speed.

4. The system of claim 3 wherein the high speed enables the monitoring device to complete transmission of the data to the mobile device in at least 30 seconds.

5. The system of claim 1 wherein the high frequency is at least 18 kHz.

6. The system of claim 5 wherein the high frequency is approximately 20 kHz.

7. The system of claim 1 wherein the monitoring device uses variable length data coding to decrease a download time for the data.

8. The system of claim 1 wherein the mobile device includes a user device or a smart phone.

9. The system of claim 1 wherein the monitoring device includes a smoke detector, a carbon monoxide detector, a fire detector, or an IoT device.

10. A method comprising:
a monitoring device transmitting, via an audio generating device, data to a mobile device in a non-audible, high frequency audio signal;
a microphone of the mobile device receiving the non-audible, high frequency audio signal; and
a processor of the mobile device decoding the data from the non-audible, high frequency audible signal.

11. The method of claim 10 further comprising the processor estimating missing portions of the data from uncorrupted portions of the data to compensate for frequency error in the non-audible, high frequency audible signal.

12. The method of claim 10 further comprising the monitoring device transmitting the data at a high speed.

13. The method of claim 12 further comprising the monitoring device completing transmission of the data to the mobile device in at least 30 seconds.

14. The method of claim 10 wherein the high frequency is at least 18 kHz.

15. The method of claim 14 wherein the high frequency is approximately 20 kHz.

16. The method of claim 10 further comprising the monitoring device using variable length data coding to decrease a download time for the data.

17. The method of claim 10 wherein the mobile device includes a user device or a smart phone.

18. The method of claim 10 wherein the monitoring device includes a smoke detector, a carbon monoxide detector, a fire detector, or an IoT device.
